(19) United States
(12) Patent Application Publication
(10) Pub. No.: US 2006/0190340 A1
(43) Pub. Date: Aug. 24, 2006

(54) Find it fast, locate an item in a store or facility

(76) Inventor: Sandra Odham Myskowski, Sinking Spring, PA (US)

Correspondence Address: Sandra Odham Myskowski, 1016 Baker Road, Sinking Spring, PA, 19608, US

(21) Appl. No.: 11/041,162

(22) Filed: Jan. 24, 2005

(51) Int. Cl. G06Q 30/00

(52) U.S. Cl. 705/26

(57) ABSTRACT

This invention comprises the processes, methods and systems for a customer or company associate to locate an item in a store or facility based solely on the name of the item or a part of the item name. To enter an item name, the customer or company associate utilizes an electronic device which can communicate with item information stored in existing company computer systems. The item name may be entered via text, by entering the letters of the item name or part of the letters of the item name, or by speaking the item name. In either case, the input is used to search the company item data bases for matching item, which are displayed to the requestor. After selection or validation of the item name, the item location is presented to the customer, in a textual manner or visual representation or a voice description.

### CROSS REFERENCE TO RELATED APPLICATIONS

20020145038 Electronic Shopping system O'Hagan, Timothy P.

### STATEMENT OF FEDERALLY SPONSORED RESEARCH/DEVELOPMENT

None

### REFERENCE TO SEQUENCE LIST

None

### BACKGROUND OF THE INVENTION

a. Field of the Invention

The present invention relates to the processes, methods and systems to assist customers and company associates to find the location of an item in a store or facility when the requestor knows only the item name or part of the item name. The invention uses information on existing company computer systems and methods in existing technologies.

b. Description of the Related Art

In the current environments in stores and facilities, signs are posted to indicate the location of groups of items, like crackers or detergents or light bulbs. Even though these signs may be helpful in locating these common items, customers still wander through the store or facility trying to find an item, for example a fly swatter.

When the customer asks a company associate for the location of the item, frequently the associate cannot find the item either. Many times the ability of the associate to locate an item is based on their longevity and familiarity at the store or facility. In addition, frequent changes in store or facility configurations change the location of items and company associates do not know the new location.

As the size of grocery stores, retail stores, home improvement stores, warehouse-type stores and other facilities have increased over the last several years, the problem for a customer or company associate to locate an item has dramatically increased. After wandering around looking for an item and asking company associates for assistance, in many cases, the customer just leaves the store or facility in frustration, without the item.

Other inventions have addressed electronic shopping in a variety of manners, including the use of electronic shopping lists, the use of bar code scans of the item, the use of coupons and other means. Some inventions emphasize the identification of customers to gain access to systems, while other inventions focus on coupon systems and manufacturer or store advertisements. Many customers do not want to become involved with these levels of sophistication.

Therefore, there is a need for a simple, easy to use process for locating an item when only the item name is known, that can be used by all customers with a varied level of technical skill. In addition, there is a need to create a simple, cost effective approach for the stores and facilities to provide this capability by using existing computer systems and existing technologies.

### SUMMARY OF THE INVENTION

This invention is designed to be used by customers and company associates to find an item in a store or facility when only the name of the item, or part of the name, is known.

The invention utilizes a variety of electronic devices for the customer to enter the item name, or part of the name, and to obtain the location of the item in the store or facility. Customer identification is not required and therefore special security processing is not required. Only the item name or part of the name is required. These devices include, but are not limited to, hand-held and stationary devices, personal computers, telephones, cellular/digital phones and personal assistant devices (PDAs). The customer enters the item name or part of the item name by using the keyboard or by speaking the item name, depending on the capabilities of the device. The item or a list of items matching the customer input is either displayed or verbalized to the customer. The customer confirms or selects the item and the location or locations of the item in the store or facility is obtained by searching company item information and is either displayed or verbalized to the customer. The location of the item may be displayed or verbalized as 1) an aisle, row and shelf, or 2) a visual representation of the location or 3) directions from the customer's location to the item location or 4) other location descriptors used in the store or facility.

The invention utilizes existing communication methods and protocols between the electronic devices and company computer systems to transmit the item name and to return the item location in the store or facility. These communication protocols include, but are not limited to, internet, intranet, extranet. LAN, WAN, WI FI, wireless, wired phone line and radio frequency.

The invention utilizes existing company information which contains the name and location of all items in a store or facility. This information is contained in these computer systems, but not limited to them: supply change management, item number and description, reorder, inventory management, Radio Frequency Identifications (RFID). The information for each item in a store or facility can be accessed by either codes and/or descriptions and contains physical location, price and other item information.

Therefore, the customer and/or company associates can use a variety of electronic devices to enter only an item name, or part of a name, and to obtain the location of the item in the store or facility. The invention is designed for customers and company associates to find any item in a store or facility quickly and easily. The customer can also view additional information relating to the item if desired, including but not limited to, price, description, advertisements, specials, other item information and other related items that may be of interest.

### BRIEF DESCRIPTION OF THE DRAWINGS

FIG. 1a and FIG. 1b provide a flowchart of the steps for entering an item name, for obtaining the item information and for relating the item location information

FIG. 2a and FIG. 2b provide an illustration of textual entry of a specific item name via a stationary keyboard device positioned in a store or facility or a mobile device with keyboard capability

FIG. 3a, FIG. 3b and FIG. 3c provide an illustration of textual entry of a part of an item name on a stationery keyboard device positioned in a store or facility or a mobile device with keyboard capability

FIG. 4 provides an illustration of voice entry of item information, including item selection and item location in a store or facility

FIG. 5 provides an illustration of the item response on a mobile device, including item selection and item location in the store or facility

FIG. 6 provides a sample of existing computer systems which contain item name and item location information

FIG. 7 provides a sample of existing communication methods and protocols which can be used to transmit information between electronic devices and company computer systems

### DETAILED DESCRIPTION OF THE INVENTION

The detail processes, methods and systems related to the invention will be described in relation to the drawings. However, the present invention is not limited to the information in the drawings.

The process of the invention is described in the flowchart in FIG. 1a and FIG. 1b, which outline three major methods of accessing information. Note that the customer does not have to provide log on information or identify themselves in any manner to gain access to the system.

In FIG. 1a, as described in the keyboard usage 10, the customer utilizes a device with a keyboard for entry of the item name or part of the item name and a display 15 for listing required information, like the item name, and for receiving information, like the item location.

FIG. 2a provides a sample representation of a display which requests the entry of an item name or part of an item name. In this sample, the customer has entered ‘flyswatter.’

In FIG. 1a, as described in the voice capability 20. The customer utilizes a voice system 25 to respond to voice prompts by speaking the item name and to receive item location information.

In FIG. 1a, a method 30 is described in which the customer has both keyboard, display and voice capabilities. The customer may choose the method 35 most comfortable to them for entering the item name and for receiving item location information.

As described in FIG. 1a, regardless of the method for entering the item name, the customer input 40 is transmitted over existing communication methods and protocols to existing computer systems which include item information.

FIG. 7 provides a sample list of existing communication methods and protocols which may be used to transmit information from the electronic devices to the company computer systems. A company may utilize or many of these communication methods and protocols or other communication methods and protocols.

FIG. 6 provides a sample list of computer systems which contain item information. A company may have one or many of these computer systems or other computer systems which contain item name and item location.

As described in FIG. 1a, a search program 45 uses the customer input and searches the company item data bases for matches. The items resulting from the search program 50 are transmitted to the electronic devices.

As described in FIG. 1b, the items resulting from the search program are presented to the customer, either through a display of information 60, through a voice responses system 70 or through the use of both the display and voice system 80.

In FIG. 1b, the customer views the item information on the display 60. If only one matching item was found, the item location is also displayed. FIG. 2b is a sample representation of the display of only one item found with the item location. In this sample, the item location is presented based on the information contained in the item data bases, as an aisle, row and bin in this example. The customer has the option of selecting choices listed on the bottom of the display to select either a visual representation of the item location or to select directions to the item.

In FIG. 1b, if multiple items 60 are found, a list of the matching items are displayed for the customer to select the item which they are seeking. After selecting the correct item, the item location 65 is displayed. FIG. 3a shows a sample representation of a display in which the customer entered part of an item name, ‘fly’. In FIG. 3b, the display shows multiple items resulting from the matching process, with instruction for the customer to select the item which he is seeking. FIG. 3c shows the item selected along with the multiple item locations. As in FIG. 2b, the item locations are presented based on the information in item data bases, an aisle, row and bin in this example. The customer has the option of selecting choices listed on the bottom of the display to select either a visual representation of the item location or to select directions to the item.

In FIG. 1b, the customer views the item information via voice response 70. If only one matching item was found, the voice response speaks the item location. FIG. 4 is a sample representation of the processes between the customer and the voice response system and outlines the detail steps of the voice interaction between the customer and the voice response system. FIG. 1b 70 describes the process if only one item or multiple items result from the customer input. In FIG. 1b 75, the item location is presented based on the information contained in the item data bases, as an aisle, row and bin in this example. The customer has the option of selecting other item location information, for example other location descriptors or directions to the item location. FIG. 4 provides additional details on the customer steps for selecting other item location information or additional item information.

In FIG. 1b, the customer is using a device with both keyboard and display and voice capabilities 80. In this case, the item information may be displayed as described in FIG. 2b and FIG. 3b and FIG. 3c or the item information maybe be communicated via a voice response system as described in FIG. 4.

FIG. 5 describes a variation of FIG. 1a and FIG. 1b in which the customer is using a mobile device which may be owned by the store or facility or may be owned by the customer. In FIG. 5, keyboard and display capability and/or telephone capability may be available with the mobile device. FIG. 5 describes the similar process of item name entry and item location response as outlined in FIG. 1a and FIG. 1b and presented in FIG. 2, FIG. 3 and FIG. 4. With a customer-owned mobile device, the customer may not have to be physically located in the store or facility.

As indicated previously, this description and examples act as representations of the invention and are not intended to be inclusive of all capabilities of the invention.

1. I claim that I am the sole inventor of ‘Find It Fast’, Locate an Item in a Store or Facility and that I solely and totally designed ‘Find It Fast’, Locate an Item in a Store or Facility to provide an easy method for customers and company associates to find an item in a store or facility by using a device to access item information containing the item location and other item-related information, for example, directions to the item location, description, price and advertisements.
